(19) United States
(12) Patent Application Publication
(10) Pub. No.: US 2007/0280240 A1
(43) Pub. Date: Dec. 6, 2007

(54) System and method for internet protocol mobility

(76) Inventor: Robert Beach, Los Altos, CA (US)

Correspondence Address: FAY KAPLUN & MARCIN, LLP, 15O BROADWAY, SUITE 702, NEW YORK, NY, 10038, US

(21) Appl. No.: 11/443,643

(22) Filed: May 31, 2006

(51) Int. Cl. H04L 12/56

(52) U.S. Cl. 370/392

(57) ABSTRACT

Described is a system and method for Internet Protocol mobility. The system includes a first network management arrangement (NMA) communicating on a first subnet of a communications network, a second NMA communicating on a second subnet of the network and a master NMA communicating on the network. The master NMA receives first data from the first NMA and second data from the second NMA. The first data includes a first identifier of the first NMA and a second identifier of the first subnet. The second data includes a third identifier of the second NMA and a fourth identifier of the second subnet. The master NMA generates network data as a function of the first and second data. The master NMA transmits the network data to the first and second NMAs. The first and second NMAs transmit packets on the network as a function of the network data.

### FIELD OF THE INVENTION

The present invention relates generally to systems and method for Internet Protocol mobility.

### BACKGROUND

Within a conventional wireless network, a subnet may include one or more access points (APs) and wireless client devices associated therewith. The network typically comprises a plurality of subnets due to, for example, spatial limitations (e.g., devices on different floors and in different buildings are on different subnets), security (e.g., different departments on different subnets), wireless traffic partitioning (e.g., limited number of client devices on each subnet), history (e.g., the network grew without planning), etc.

In the conventional wireless network, when the client device roams within the subnet (i.e., the subnet has at least two APs), it may maintain its Internet Protocol (IP) address. However, when the client device roams to a different AP in a different subnet, the client device is assigned a new IP address. Changing IP addresses may be problematic, because, it is difficult to maintain UDP/TCP sessions, certain applications (e.g., voice communications) require a fixed IP address, etc. For example, if the client device is engaged in a voice communication session and roams to the different AP in the different subnet, the communication session may be terminated because the client device is assigned the new IP address. Thus, there is a need for IP mobility, allowing the client device to move within the network while maintaining a single IP address.

### SUMMARY OF THE INVENTION

The present invention relates to a system and method for IP mobility. The system includes a first network management arrangement (NMA) communicating on a first subnet of a communications network, a second NMA communicating on a second subnet of the network and a master NMA communicating on the network. The master NMA receives first data from the first NMA and second data from the second NMA. The first data includes a first identifier of the first NMA and a second identifier of the first subnet. The second data includes a third identifier of the second NMA and a fourth identifier of the second subnet. The master NMA generates network data as a function of the first and second data. The master NMA transmits the network data to the first and second NMAs. The first and second NMAs transmit packets on the network as a function of the network data.

### DESCRIPTION OF THE DRAWINGS

FIG. 1 shows an exemplary embodiment of a system for IP mobility according to the present invention.

FIG. 2 shows an exemplary embodiment of an initialization process for an infrastructure device according to the present invention.

FIG. 3 shows an exemplary embodiment of a system for transferring roam update information throughout the system according to the present invention.

FIG. 4 shows an exemplary embodiment of a method for routing packets according to the present invention.

FIG. 5 shows an exemplary embodiment of a system for routing packets with a known destination address according to the present invention.

FIG. 6 shows an exemplary embodiment of a system for routing packets with an unknown destination address according to the present invention.

FIG. 7 shows an exemplary embodiment of a distributed system for IP mobility according to the present invention.

FIG. 8 shows an exemplary embodiment of a centralized system for IP mobility according to the present invention.

FIG. 9 shows an exemplary embodiment of a broadcast in a system according to the present invention.

### DETAILED DESCRIPTION

The present invention may be further understood with reference to the following description and the appended drawings, wherein like elements are referred to with the same reference numerals. The present invention describes a system and method for Internet Protocol (IP) mobility for client devices on a communications network. While the exemplary embodiments are described with reference to wireless client and infrastructure devices operating in a wireless communications network, those of skill in the art will understand that the present invention may be implemented on any computing device operating in any communications network in which maintaining a single identification of the device is beneficial to operation of the device and/or the network.

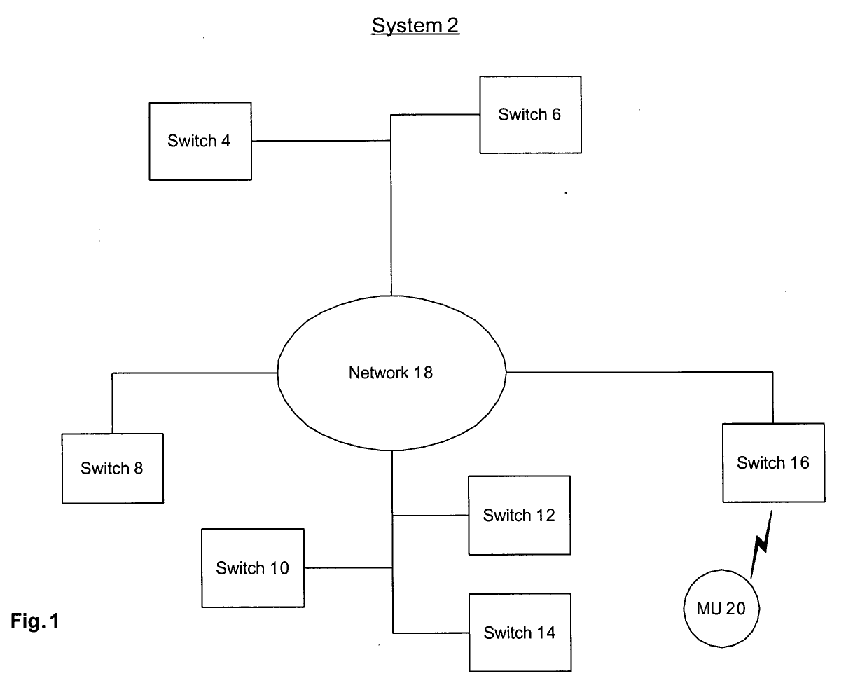

FIG. 1 shows an exemplary embodiment of a system 2 for IP mobility according to the present invention. The system 2 includes a plurality of wireless communication infrastructure devices (e.g., switches 4-16) interconnected on a wireless communications network 18 (e.g., a OSI Model Layer 3 network). In the exemplary embodiments of the present invention, the switches 4-16 are integral with and/or coupled to access points/ports (APs) which allow mobile units (MUs), such as MU 20, to gain access to the network 18 and receive traffic therefrom. Although the APs are not shown in the appended drawings and the exemplary embodiments are described as the MU 20 negotiating access to the network 18 with the switches 4-16, those of skill in the art will understand that functionality of the APs is included with, or extended to, the switches 4-16. Those of skill in the art will further understand that the MU 20 may be any wireless computing device including, but not limited to, an imager-/laser-based scanner, an RFID reader/tag, a mobile phone, a PDA, a tablet, a network interface card, a laptop, etc.

In the exemplary embodiments of the present invention, the switches 4-16 operate at Layer 2 of the OSI Model and preferably include virtual local area network (VLAN) capabilities. For example, a particular wireless LAN (WLAN) comprising a basic service set (BSS) or an extended service set (ESS), i.e., two or more BSSs, may be mapped to a VLAN. As a result, all MUs which communicate on the particular WLAN are placed into the VLAN. The switches 4-16 may support multiple WLAN-to-VLAN mappings concurrently. In a preferred exemplary embodiment, all switches which support the particular WLAN are mapped to the same VLAN which, as understood by those skilled in the art, allows the system 2 to operate on Layer 2. All of the WLANs supported by the switches 4-16 are mapped into corresponding VLANs, generating an extended set of VLANs, or extended VLAN (eVLAN). As will be described further below, the exemplary embodiments of the present invention extend the VLANs beyond their corresponding physical geographical boundaries so that, for example, switches located in different buildings may be included (or at least appear to be included from the MU's point of view) on a same subnet of the network 18.

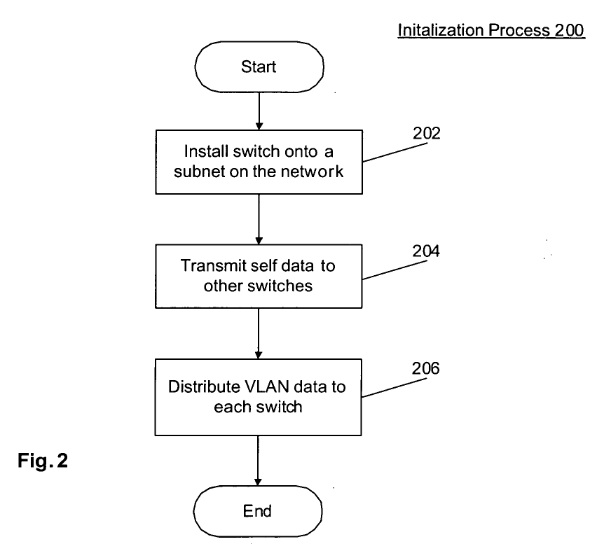

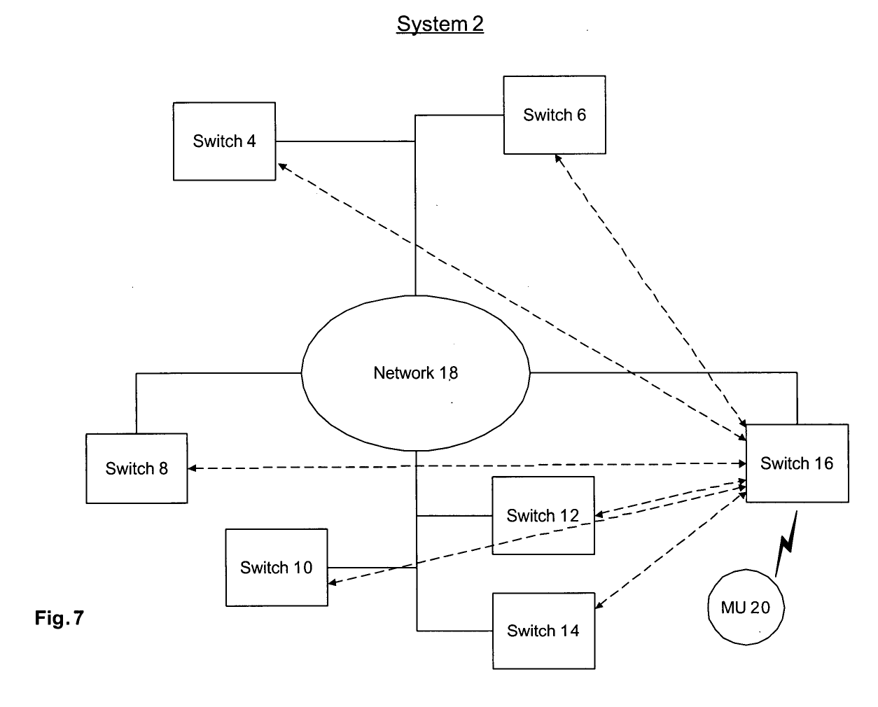

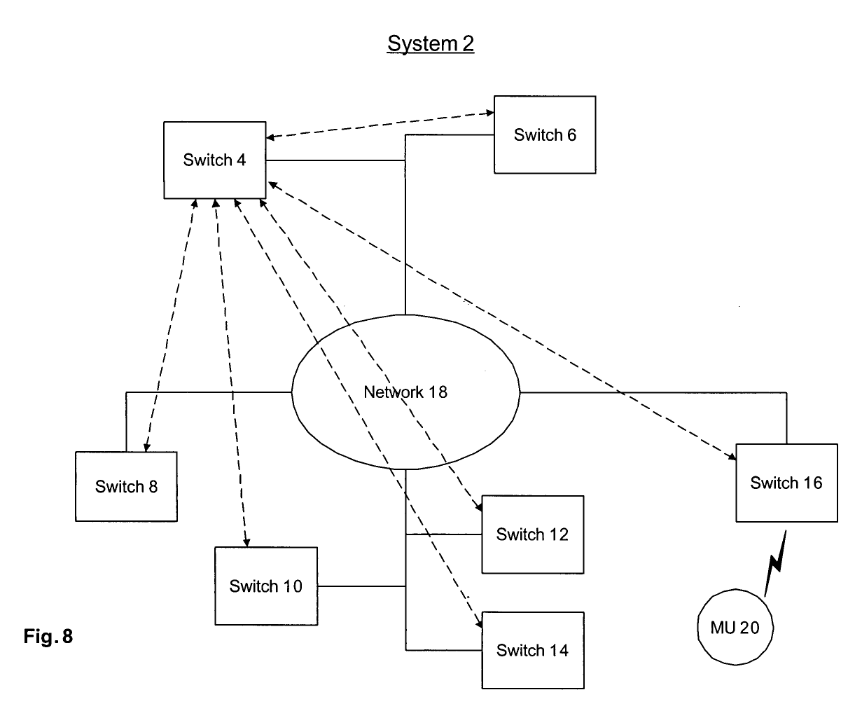

FIG. 2 shows an exemplary embodiment of an initialization process 200 performed when a switch (e.g., the switch 16) is introduced to and/or powered up on the network 18. In step 202, the switch 16 is installed onto a subnet on the network 18. In step 204, the switch 16 transmits device data to the other switches on the network 18. In one exemplary embodiment, the switch 16 establishes tunnels to every other switch, or selected switches, on the network 18 and transmits the device data (e.g., IP address, subnet mask, etc.) to the other switches (e.g., the switches 4-14), as shown in FIG. 7. For example, the switch 16 may establish tunnels to at least one preselected switch in each subnet (e.g., switches 4, 8 and 10), and the preselected switches may distribute the device data to the other switches in their subnet, e.g., the switch 10 transmits the device data to the switches 12 and 14. In another exemplary embodiment, the switch 16 transmits the device data to a management entity (e.g., master switch, MSP, etc.) which then distributes the device data to each of the switches on the network 18, or the preselected switches, as shown in FIG. 8. While the exemplary embodiment of the initialization process 200 will be described with reference to the management entity, those of skill in the art will understand that the switches 4-16 may conduct the process 200 without use of the management entity by, for example, communicating directly with each other. Those of skill in the art will understand that the transmissions including the device data may include an authentication token for validating the device data and may be encrypted.

In step 206, the management entity receives the device data from the switch 16 and distributes VLAN data to all, or selected ones, of the switches (including the switch 16) on the network 18. The VLAN data may include an IP address of each switch and a VLAN identifier for each VLAN supported by the switch. There may be a sequence associated with the distribution of the VLAN data to detect updates from duplicates. Those of skill in the art will, understand that the transmissions of the VLAN data may include an authentication token for validating the transmissions and may be encrypted.

Included with the transmission of the VLAN data or in a separate transmission, the management entity may identify at least one switch on the network 18 as an attachment point to a wired VLAN, e.g., an IP address of a device acting as a gateway to a wireline portion of the network 18. The attachment point may be useful for the switches 4-16 to know when routing packets, as will be explained further below. Once the switch 16 is operational, initialized and authorized to communicate on the network 18, it may function in conjunction with the other switches 4-14 to manage communications on the network 18.

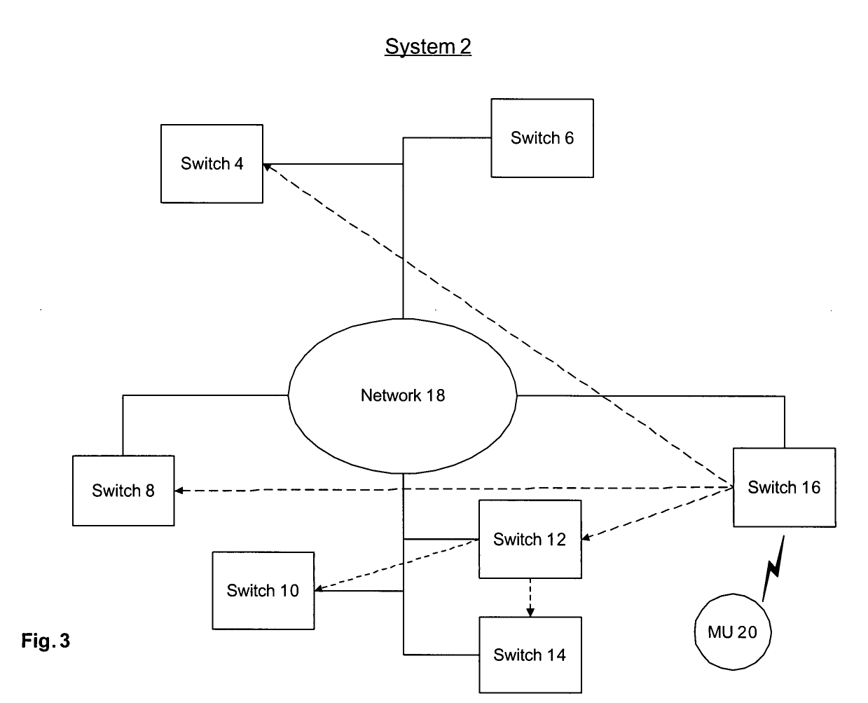

According to the exemplary embodiments of the present invention, the switches 4-16 may share information about associated MUs to optimize performance of the MUs and throughput in the network 18. For example, as shown in FIG. 3, the MU 20 associates with the switch 16 and conducts an authentication handshake as is known in the art. Those of skill in the art will understand that initiation of a communication session between the MU 20 and the switch 16 may occur when the MU 20 is powered up or when the MU 20 roams to the switch 16. In either embodiment, the switch 16 transmits roam data to the other switches 4-14 indicating that the switch 16 services the MU 20, i.e., is a path for communications addressed to the MU 20. The roam data may include, but is not limited to, a MAC address and VLAN identifier of the MU 20, the IP address of the switch 16 (i.e., the switch the MU has roamed to), a sequence number, authentication information/keys, performance statistics, packet types (voice/data), priority information, an authentication token for validation of the roam data, etc.

As described above with reference to the device data, the roam data may be transmitted directly to the other switches 4-14 on the network 18 by the switch 16, or the switch 16 may transmit the roam data to the preselected switches in the system 2, which forward the roam data to other switches on their corresponding subnets. In the latter exemplary embodiment, the roam data may further include an instruction to the preselected switches to redistribute the roam data to the other switches on the corresponding subnets. For example, the instruction to the switch 12 may cause it to redistributed the roam data to the switches 10 and 14, as shown in FIG. 3.

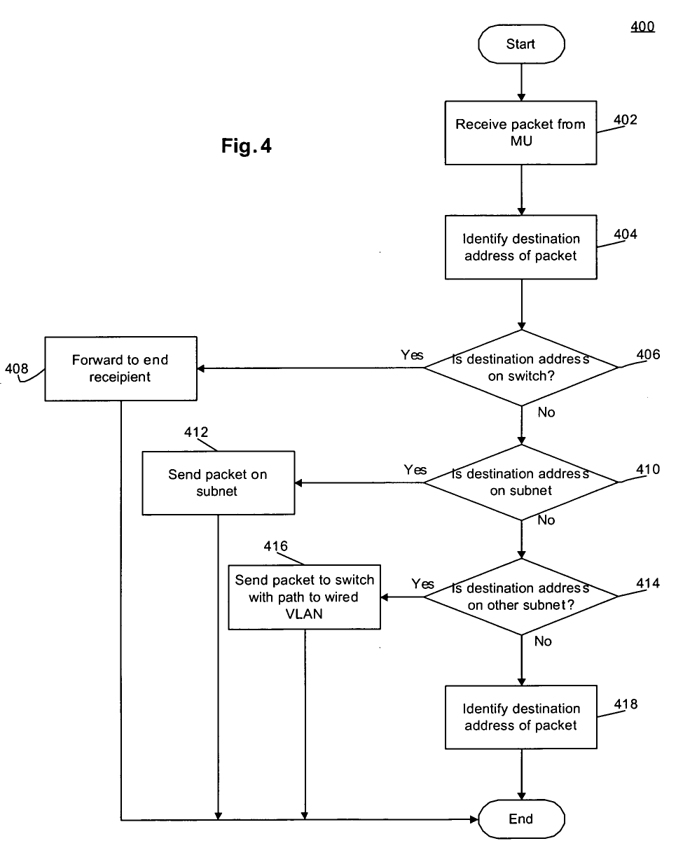

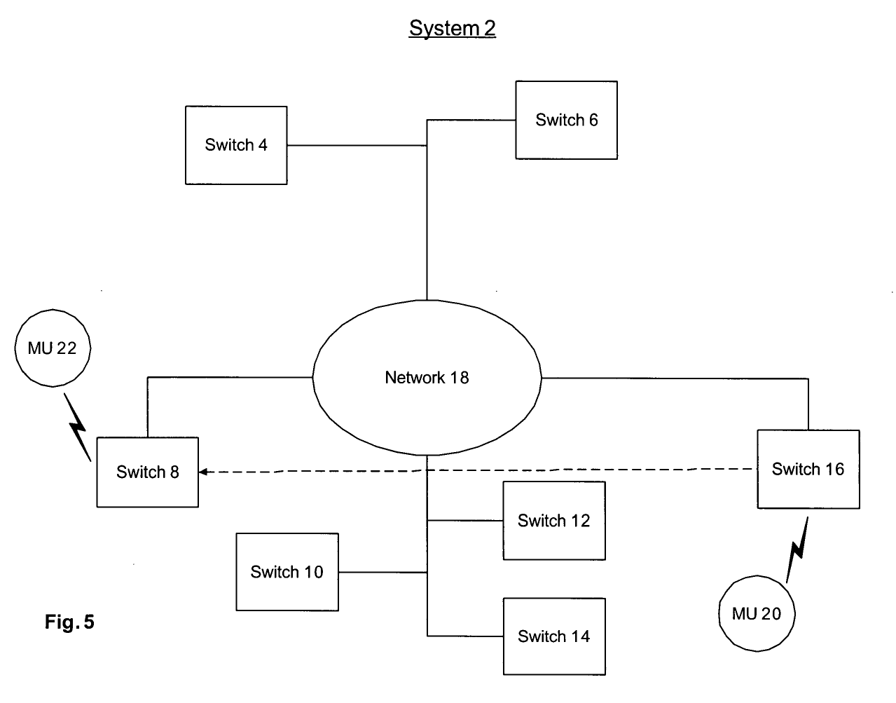

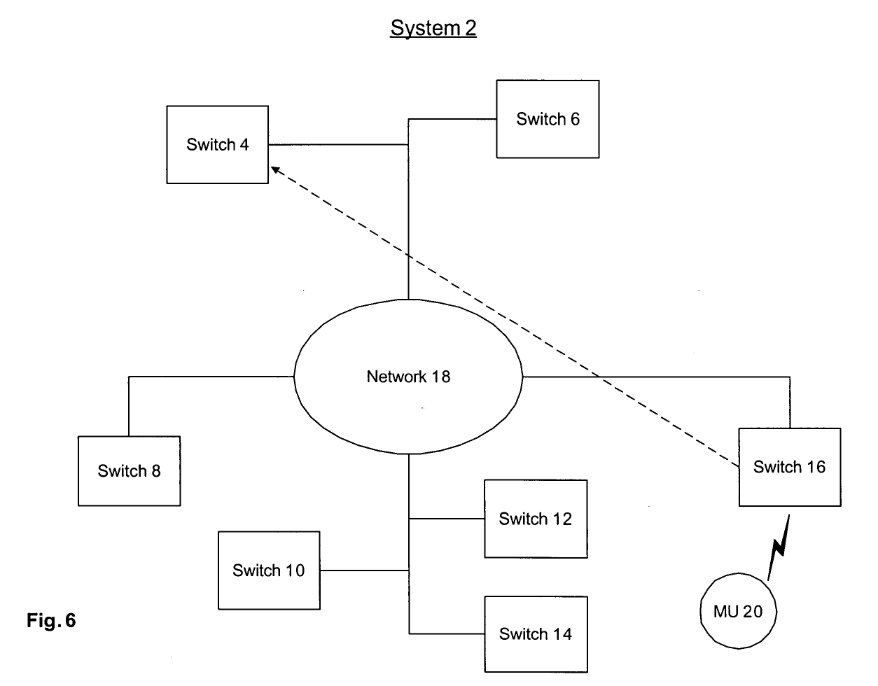

FIG. 4 shows an exemplary embodiment of a method 400 for packet routing in the system 2 which will be described in conjunction with the system 2 as shown in FIG. 5 and FIG. 6. In step 402, the switch 16 receives a packet from the MU 20. In step 404, the switch 16 identifies a destination address of the packet, i.e., an end recipient of the packet (e.g., MU 22 in FIG. 5). As understood by those of skill in the art, the destination address may be identified by examining a header on the packet which may include data in up to four address fields. The destination address of the end recipient is found in either a first address field or a third address field depending on whether a ToDS bit is set. When the packet is transmitted from the MU 20 to the switch 16, the ToDS bit may be set, so the destination address would be located in the third address field. Alternatively, when the packet is transmitted between switches, the destination address may be located in the first address field.

In step 406, the switch 16 determines whether the destination address is an address of a device which the switch 16 is currently servicing. For example, referring to FIG. 5, if the MU 22 was associated with the switch 16, the switch 16 may forward the packet directly to the MU 22, as shown in step 408.

When the switch 16 is not servicing the destination address, the method 400 proceeds to step 410 where the switch 16 determines whether any switch on its subnet is servicing the destination address. In this manner, the switch 16 may analyze the roam data it has received from the other switches on its subnet. If another switch on the same subnet is servicing the destination address, the switch 16 sends the packet to that switch over the subnet, as shown in step 412. As shown in FIG. 5, there are no other switches on the same subnet as the switch 16, so the method 400 proceeds to examine the roam data from the switches on the other subnets in the system 2.

In step 414, the switch 16 determines whether a switch in another subnet services the destination address by examining the roam data received from the switch(es) in those subnet(s). For example, as shown in FIG. 5, the destination address corresponds to the MU 22 which is associated with the switch 8. As described above, the switch 8 would have transmitted the roam data corresponding to the MU 22 when the MU 22 associated with the switch 8. Thus, the switch 16 analyzes the roam data from the switches from the different subnets (other than its own) to determine which switch is currently servicing the destination address. When the switch 16 determines that another switch (e.g., the switch 8) is servicing the destination address, the switch 16 transmits the packet to the switch 8, as shown in step 416. The packet may be transmitted via a tunnel between the switches 8 and 16 which was generated during the initialization process of either switch, as described above. Tunneled packets may be, for example, 802.3/Ethernet formatted packets, rather than 802.11 format, and may be encrypted. The tunneled packets may be encapsulated according to a conventional encapsulation protocol, e.g., Generic Routing Encapsulation (GRE).

In step 418, the switch 16 has determined that none of the switches in the system 2 (from which it has received the roam data) are currently servicing the destination address, so it transmits the packet to a switch having a path to the wired VLAN, e.g., the switch 4, as shown in FIG. 6. The switch 4 forwards the packet to a distribution system for delivery as is conventionally known.

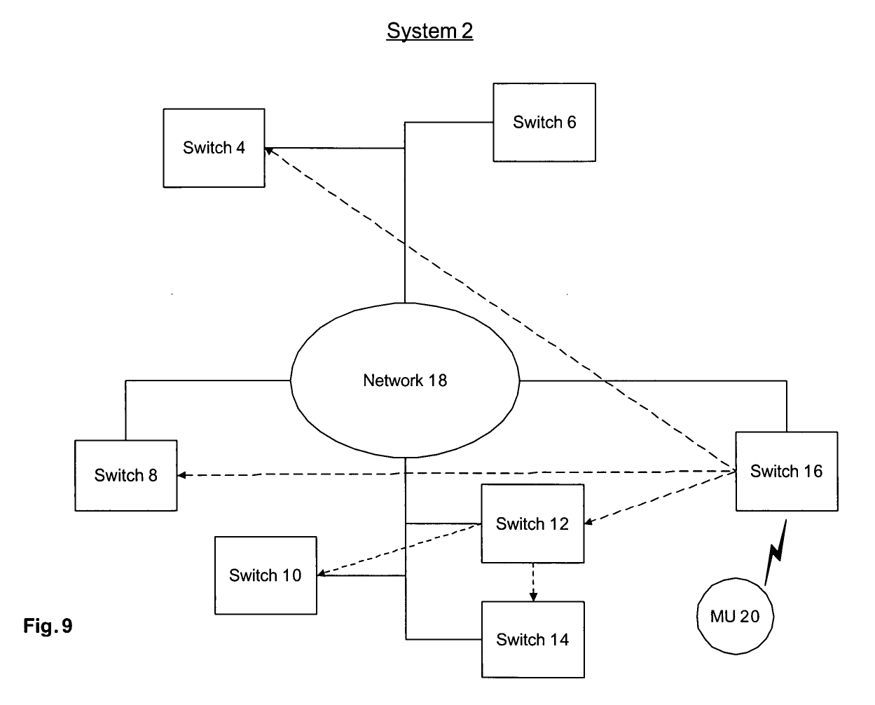

The exemplary embodiments of the present invention also provide for a procedure for transmitting broadcast packets on the system 2. As shown in FIG. 9, the broadcast packet may be transmitted in a similar manner as the device data and/or roam data. Thus, the broadcast packet is ensured to reach all of the switches in the system 2.

The system 2 according to the present invention is robust, because if a switch should fail, the MUs associated with the failed switch may seamlessly roam to a new switch, because the new switch has the roam data (along with, e.g., certificates, keys, QoS state, etc.) from the failed switch. However, if a switch connected to the wireline portion of the network 18 fails, ports connected to the failed switch are taken over by other switches. That is, connectivity to the network 18 remains operational since it is provided by the wired L2 VLAN to which all the switches are connected. Similarly, the eVLAN maintains a path to the wired VLAN via any of the switches present on the wired VLAN (e.g., the switch 4). Thus, the system 2 is robust, because one switch on any given subnet may reach the network 18 gateway on the wired VLAN.

The present invention provides several advantages in terms of roaming, data routing, system throughput, etc. For example, a roam update is quickly propagated to all switches in the system 2 allowing for transmission path recognition and efficient packet routing. In addition, the switch which previously serviced the MU may transmit state data (e.g., security keys, QoS state, user information, etc.) to the switch which the MU has roamed to. Also, using the present invention, packet routing becomes point-to-point without any intermediate handlers, decreasing packet transmission times.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A network management device, comprising:
a communications arrangement transmitting device data to at least one further network management device of a communications network, the device data including a device identifier and a subnet identifier, the subnet identifier being indicative of a subnet of the communications network served by the device, the communications arrangement receiving further device data from the at least one further network management device, the further device data including a further device identifier and a further subnet identifier for each of the at least one further network management device; and
a processor generating network data as a function of the device data and the further device data,
wherein, when the communications arrangement receives a packet addressed to a destination device, the processor transmits the packet as a function of the network data.

2. The device according to claim 1, wherein the device data and the further device data include a list of virtual local area networks (VLANs) supported by the device and the at least one further network management device, respectively.

3. The device according to claim 1, wherein the device identifier is an Internet Protocol (IP) address of the device and the subnet identifier is a subnet mask of the device, and the further device identifier is a further IP address of each of the at least one further network management device and the further subnet identifier is a further subnet mask of each of the at least one further network management device.

4. The device according to claim 1, wherein the device data and the further device data include mobile unit identifiers indicative of mobile units associated with the device and the at least one further network management device, respectively.

5. The device according to claim 4, wherein the mobile unit identifiers include at least one of a MAC address and a VLAN identifier of each of the mobile units.

6. The device according to claim 4, wherein, when a selected mobile unit associated with the device terminates a communication session with the device and associates with a selected one of the at least one further network management device, the communications arrangement receives roam data from the selected further management device, the roam data including the mobile unit identifier of the selected mobile unit.

7. The device according to claim 6, wherein, upon receipt of the roam data, the communications arrangement transmits state data corresponding to the selected mobile unit to the selected further management device.

8. The device according to claim 7, wherein the state data includes at least one of a security key, a certificate, a Quality-of-Service (QoS) state, a packet type and a priority level.

9. A system, comprising:
a first network management arrangement (NMA) communicating on a first subnet of a communications network;
a second NMA communicating on a second subnet of the network; and
a master NMA communicating on the network, the master NMA receiving first data from the first NMA and second data from the second NMA, the first data including a first NMA identifier of the first NMA and a first subnet identifier of the first subnet, the second data including a second NMA identifier of the second NMA and a second subnet identifier of the second subnet, the master NMA generating network data as a function of the first and second data, the master NMA transmitting the network data to the first and second NMAs, wherein the first and second NMAs transmit packets on the network as a function of the network data.

10. The system according to claim 9, wherein the first NMA identifier is an IP address of the first NMA, the first subnet identifier is a subnet mask of the first NMA, the second NMA identifier is an IP address of the second NMA and the second subnet identifier is a subnet mask of the second NMA.

11. The system according to claim 9, wherein, when a communication session is established between the first NMA and a wireless computing unit, the first NMA generates roam data as a function of the first data and unit data corresponding to the unit, the first NMA transmits the roam data to the master NMA for distribution to the second NMA.

12. The system according to claim 11, wherein when the first NMA receives a packet from the unit, the first NMA identifies a destination address of the packet and determines a transmission path for the packet as a function of at least one of (i) the network data and (ii) further roam data received from the master NMA indicative of a further communication session between a further wireless computing unit and the second NMA.

13. The system according to claim 12, wherein the network data includes an identifier for an attachment point to a wired VLAN.

14. The system according to claim 13, wherein when the further wireless computing unit is unknown to the first NMA based on the network data and the further roam data, the first NMA transmits the packet to the attachment point.

15. The system according to claim 12, wherein when the communication session is terminated, the first NMA receives the further roam data from the second NMA indicating that the unit has established a further communication session with the second NMA, and the first NMA transmits state data corresponding to the unit to the second NMA.

16. The system according to claim 15, wherein the state data includes at least one of a security key, a certificate, a QoS state, a packet type and a priority level.

17. A method, comprising:
transmitting, by a first network management arrangement (NMA), first data to a second NMA on a communications network, the first data including a first NMA identifier of the first NMA and a first subnet identifier of a first subnet of the network on which the first NMA communicates;
receiving second data from the second NMA, the second data including a second NMA identifier of the second NMA and a second subnet identifier of a second subnet of the network on which the second NMA communicates; and
transmitting packets on the network as a function of the network data.

18. The method according to claim 17, wherein the first and second data includes a list of VLANs supported by each of the first and second NMAs, respectively.

19. The method according to claim 17, further comprising:
establishing a first communication session with a first wireless computing unit;
generating roam data as a function of the first data and first unit data corresponding to the first unit; and
transmitting the roam data to the second NMA.

20. The method according to claim 19, wherein the first unit data includes at least one of a MAC address and a VLAN identifier of the first unit.

21. The method according to claim 19, further comprising:
receiving a packet from the first unit;
identifying a destination address of the packet; and
determining a transmission path for the packet as a function of the second data.

22. The method according to claim 21, wherein the second data includes at least one further NMA identifier of at least one further NMA and at least one further subnet identifier of at least one further subnet of the network on which the at least one further NMA communicates.

23. The method according to claim 19, further comprising:
when the first communication session is terminated, receiving further roam data from the second NMA indicating that the first unit has established a further communication session with the second NMA; and
transmitting state data corresponding to the first unit to the second NMA.

24. A network management device, comprising:
a communications means for transmitting device data to at least one further network management device of a communications network, the device data including a device identifier and a subnet identifier, the subnet identifier being indicative of a subnet of the communications network served by the device, the communications means receiving further device data from the at least one further network management device, the further device data including a further device identifier and a further subnet identifier for each of the at least one further network management device; and
a processing means for generating network data as a function of the device data and the further device data,
wherein, when the communications means receives a packet addressed to a destination device, the processing means transmits the packet as a function of the network data.
